(19) United States
(12) Patent Application Publication
(10) Pub. No.: US 2008/0223529 A1
(43) Pub. Date: Sep. 18, 2008

(54) MOUNTING LEVER

(76) Inventor: Stephen C. Nemish, Valley Park, MO (US)

Correspondence Address: CHARLES C. MCCLOSKEY, 763 S. NEW BALLAS ROAD STE. 170, ST. LOUIS, MO, 63141, US

(21) Appl. No.: 11/685,013

(22) Filed: Mar. 12, 2007

(51) Int. Cl. B60C 25/04

(52) U.S. Cl. 157/1.3

(57) ABSTRACT

A manual device, for use in tire changing without power equipment, provides an angled lever with a non-marring head. The head grips the rim of a wheel and allows rotation of the lever upon the rim without marring the wheel. The mounting lever has a non-marring head connected to a flat bar of a length to manually manipulate a tire bead onto and off a rim. The non-marring head has a channel to grip the rim and a leading portion curved to guide the bead over and onto the rim. The flat bar of the mounting lever has an offset angle from the head to aid a worker in grasping the mounting lever during usage with less of a risk of injury to the knuckles.

### BACKGROUND OF THE INVENTION

The mounting lever generally relates to manual tire changing machinery and more specifically to a flat lever with a head that does not mar a wheel.

In bays and shops around the world, numerous tires are changed from wheels every day. During a tire change, a worn or damaged tire is removed from a wheel and a new tire is installed. Tires have sidewalls upon both sides of the tire that extend partially towards the center. At the innermost portion of the sidewall, the tire has an encased bead. The bead is a thickened portion of the sidewall surrounding metal wire. A wheel generally has two parallel rims, upon the circumference of both sides of the wheel. The rims have a greater diameter than the substantial portion of the circumference.

Tire changing involves mounting a tire upon a wheel or removing a tire from a wheel. A common tool used in tire changing is the spoon. A spoon is an elongated bar, generally round, with one end, the head, flattened and curved opposite a handle. The spoon has sufficient length to provide leverage to a worker during usage. For mounting a tire upon a wheel, the wheel is clamped into a fixed position. One bead is placed over a rim as much as possible and then the head of a spoon is placed upon the rim to stretch the remainder of the bead onto the rim. The other side of the tire is installed in a similar manner. Inflating the tire then seats both beads against their respective rims. For removing a tire from a wheel, the wheel is clamped again into a fixed position. The tire is partially deflated and then the head of a spoon is inserted between the bead and a rim with the handle positioned towards the tire. The handle is then rotated toward the center of the wheel thus the head lifts and stretches the bead from the rim. The worker then moves the head around the rim to separate the bead from the rim. As before, the second bead undergoes the same demounting procedure.

Wheels are used on many vehicles. On utility vehicles, the appearance of wheels matters less so than on personal vehicles. For automobiles, motorcycles, and some boat trailers, the wheels and their appearance have high importance to their drivers. People often place great emphasis on the appearance of wheels as part of their self image. The after market in wheels of all kinds exceeds $5 million in annual sales. Often, people buy shiny, or novelty, wheels to customize vehicles. In particular, motorcycles have shiny wheels including spokes and rims. The shine upon the wheels arises from metal alloy, or metal plating, upon the wheel, particularly the rim. Alloys and plating are readily damaged by the harder materials usually contained in shop tools and equipment. So much so that shop tools and equipment are known to mar wheels. The owners of shiny wheels have little tolerance, both aesthetically and financially, for shop caused blemishes upon their wheels.

### DESCRIPTION OF THE PRIOR ART

Traditionally, wheels, even shiny wheels, have been clamped for tire balancing and other procedures. The metal clamps are generally made of steel or other alloy. The hardness of the steel clamps allows the clamps to mar hubs of softer material, such as aluminum and its alloys. Once clamped in place, a typical tire can be changed manually using spoons. Spoons are long handled tools with a flat head, generally made of steel. The long handle provides the leverage for a worker to manipulate a portion of a bead onto and off the rim of a wheel. The flat head has a generally oblong planar shape, often hammered from the handle. The flat head is inserted between the bead and the rim to pull the bead from the rim in demounting and to push the bead onto the rim in mounting.

Prior art bars also have a hook end. The hook connects inside of the rim and the bight of the hook presses the tire sidewall downwardly for mounting of the tire. As a single point of contact, the hook presses a portion of the sidewall but does not reach the relief valley of the wheel to seat the bead. Once the flat head, or hook, has engaged the bead, the spoon is rotated around the rim to seat or to unseat the bead. As the typical spoon is steel, the spoon slides along the rim and abrades the rim surface. In time, the abrasions of the rim accumulate and discolor the finish of the rim or even cause rust upon ferrous rims.

The prior art has many spoons and tools to manipulate the bead of tires. However, the prior art shares the common disadvantage of marring the rim of a wheel. The handle and head of an existing steel spoon contact nearly the entire circumference of the rim upon both sides during tire mounting and demounting. Depending on wheel hardness, the spoon may mar the entire rim. Marring leads to discoloration, rust, and an unsightly appearance. For drivers and motorcyclists sensitive to the appearance of their wheels, marring is not acceptable.

The present invention overcomes the difficulties of marring a wheel during mounting and demounting of tires using manual tools at garages and small shops.

### SUMMARY OF THE INVENTION

Generally, the present invention provides an angled lever with a head that grips the rim of a wheel and the sidewall components of a tire without marring the wheel. The mounting lever has a non-marring head connected to a flat bar of suitable length to manually manipulate a tire bead onto and off of a rim. The non-marring head has a channel to grip the rim and a leading portion curved to grasp the bead. The flat bar of the mounting lever has an offset angle from the head to aid a worker in grasping the mounting lever during usage.

There has thus been outlined, rather broadly, the more important features of the invention in order that the detailed description thereof that follows may be better understood and that the present contribution to the art may be better appreciated. The present invention also includes mechanical fastening of the head to the lever, adhesive fastening of the head to the lever, a hole through the lever opposite the head, and a curved end to the lever opposite the head. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved mounting lever.

Another object is to provide such a mounting lever that operates without marring the surface of a wheel.

Another object is to provide such a mounting lever that permits replacement of its head once worn during usage.

Another object is to provide such a mounting lever that moves around a wheel rim without power tools.

Another object is to provide such a mounting lever that inserts between a seated bead and a wheel rim to assist in mounting and demounting a tire upon the wheel.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a top view of the present invention located upon a wheel and tire;

FIG. 2 shows a top view of the present invention;

FIG. 3 describes a side view of the present invention;

FIG. 4 describes a front view of the head and handle of the present invention;

FIG. 5 shows a side view of the head;

FIG. 6 shows a front view of the head;

FIG. 7 shows a top view of the head; and,

FIG. 8 illustrates a bottom view of the head.

The same reference numerals refer to the same parts throughout the various figures.

### DESCRIPTION OF THE PREFERRED EMBODIMENT

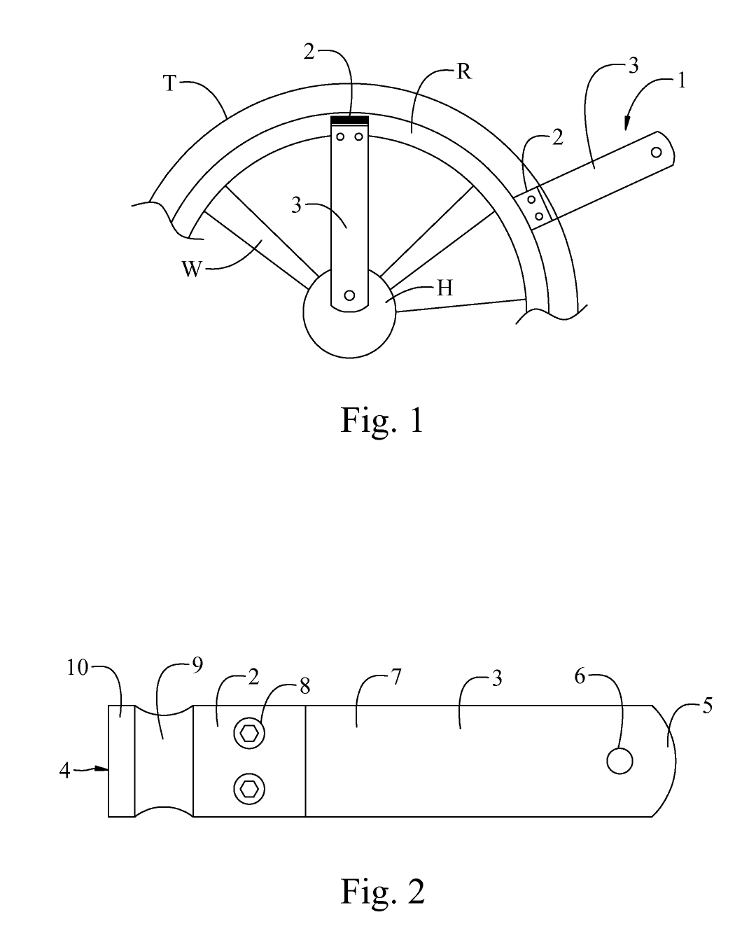

The present art overcomes the prior art limitations by providing a mounting lever 1 with a head 2 upon an elongated handle 3 that connects to a wheel for mounting or demounting a tire T from the rim of the wheel W in FIG. 1. In this view, the head is shown just inside of the rim R where the handle rests upon the sidewall of a tire at approximately the two o'clock position. The mounting lever assists a worker in manually mounting and demounting a tire. The mounting lever moves a bead of a tire over the rim of a wheel and holds a tire upon the wheel as other tools are used, such as the mount/demount bar of the inventor. The mounting lever can be used singly or with a plurality. To illustrate a plurality, another mounting lever is shown at the twelve o'clock position but with the handle upon the wheel towards the hub H.

FIG. 2 shows the mounting lever from the top in a view generally associated with mounting of a tire upon a wheel. The handle 3 has a generally elongated rectangular form with two opposite ends. The first end 4 has the head 2 and the second end 5 provides a place for a worker to grip the mounting lever 1. The second end is rounded without any corners for the comfort of the worker and has a hole 6 therethrough. The hole allows for placing the invention upon a peg in a tool room or attachment of a cord to secure the invention. In an alternate embodiment, the second end is square with two corners and straight edges. Away from the second end, the handle has a bend 7 that angles the handle away from the centerline of the tool through the first head. The bend offsets the handle away from the plane of the head 2 so a worker can grasp the mounting lever 1 when the head is generally flat upon a rim and the handle is above a hub H during mounting of a tire.

The head two connects to the handle with two screws 8 that turn into matching threaded holes in the handle. The head 2 is upon the face of the handle opposite the bend. In the preferred embodiment, the screws have hex head apertures for turning though alternative apertures, such as TORX™ are possible. Outwardly from the screws 8 and the bend 7, the head has a channel 9 that extends perpendicular to the centerline of the mounting lever. The channel is generally semicircular in cross-section of a certain diameter. Alternatively, the channel can have a cross-section in elliptical or V shape. The channel extends to approximately one half of the thickness of the head. Adjacent to the channel is the leading edge 10 locating at the first end 4 of the handle. The leading edge is rounded to guide the head around a rim when the handle is rotated from over a hub to over a sidewall of a tire during mounting.

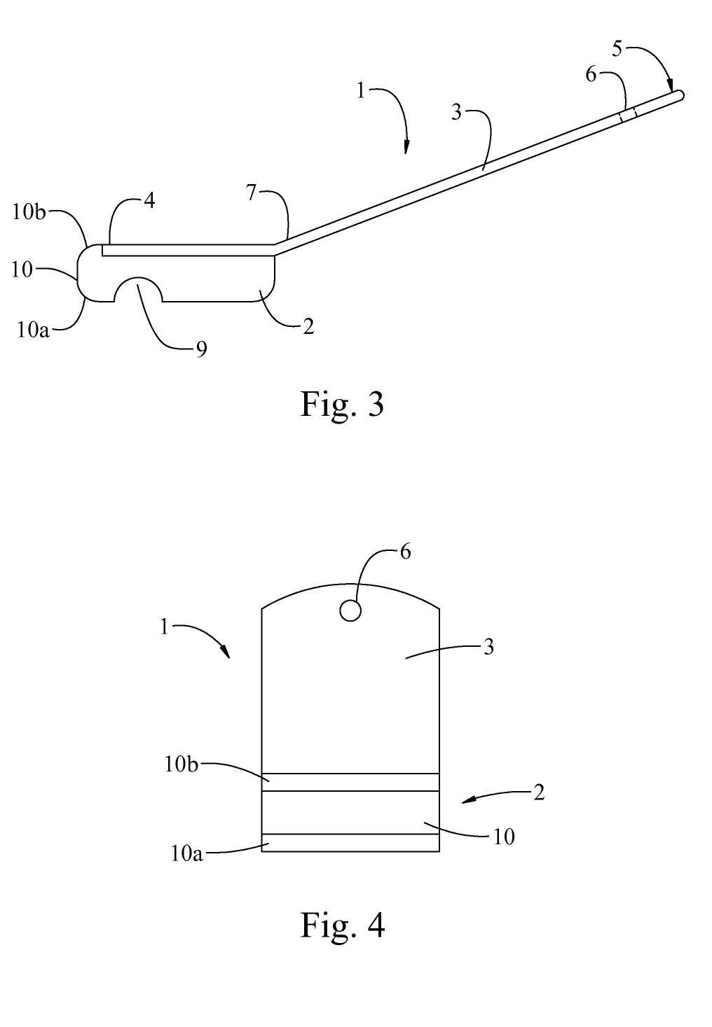

The bend 7 of the handle 3 then appears in FIG. 3, a side view of the invention 1. As described above, the handle has two ends with a second end having a hole 6 and location away from the first end. Away from the second end the handle 3 has a bend 7 that raises the handle, particularly the second end 5 above the plane of the head. This orientation of the handle allows a worker to grip the handle 3 in the vicinity of the second end and limits knuckle damage. Away from the bend towards the first end 4, the handle has the first head 2 locating below the handle 3 and opposite the angle of bend. The first head 2 has a channel 9 across its width, generally semi-circular in cross section. Outwardly from the bend and the channel, the head 2 has the leading edge 10. The leading edge is rounded at its top 10a and bottom 10b across the width of the invention. The bottom extends down the thickness and across the width of the first end 4. The leading edge 10 also extends outwardly from the first end 4 approximately the radius of the channel 9. The extension of the leading edge protects a rim R from marring by the first end 4 of the handle 3. Though a rounded top 10a and bottom 10b are described for the leading edge 10, other shapes such as square corners, a beveled face, and a semi-circular leading edge are alternatives.

FIG. 4 shows the invention from the front of the head 2 extending rearward with the leading edge 10 in the foreground. As before the top 10a and the bottom 10b are rounded to ease passage of the head between a rim R and the bead of a tire. The handle 3 extends rearward from the leading edge and also upward from the leading edge at an acute angle. The angle of the handle spaces away a worker's hand when grasping the invention during the initial steps of mounting a tire upon a rim. Away from the head, the handle has the second end 5 shown with a hole 6 therethrough. The hole is generally centered and approximately three times the thickness of the handle in diameter. The hole allows a worker to hang the invention from a hook when not in use.

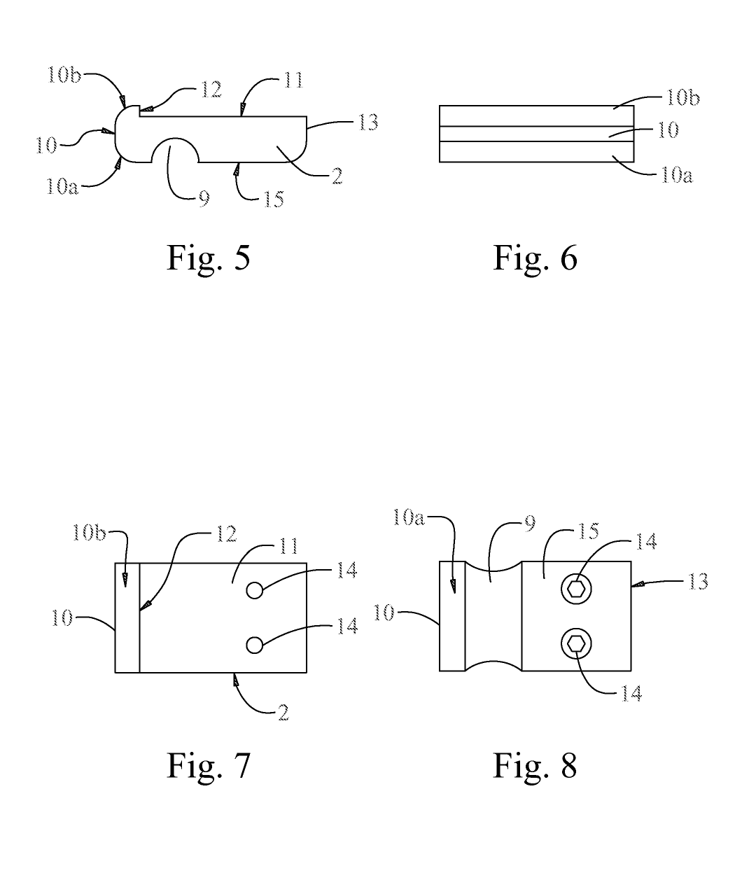

The head is now further described in the following figures. FIG. 5 shows the head from the side and as the head is symmetric about its lateral centerline, the following description applies to both sides of the head. The head 2 generally attaches to the first end 4 of the handle 3. The first end attaches flatly upon the head 2 upon the surface 11. The surface has enough width to space apart the screws 8 from the channel 9. The surface 11 is generally parallel to the first end and extends for a substantial portion of the length of the head and across the width of the head. The surface abuts the top 10b at a right angle to capture the first end in a butt joint against an edge 12. The edge is perpendicular to the surface and is generally located between the edge of the channel and the leading edge 10. The edge 12 extends away from the surface 11 for approximately the thickness of the handle. The edge 12 and the top 10b form a flush and smooth joint between the head and the first end for further eliminating marring during usage of the present invention.

Below the top 10b, the leading edge 10 rounds over to the bottom 10a and the bottom continues to a second surface 15. The second surface is parallel to and spaced below the surface 10. The second surface includes the channel 9 as previously described. The second surface continues away from the channel towards the first end of the handle. The second surface then rounds over to the trailing edge 13 that returns the shape of the head to the first end of the handle.

FIG. 6 again shows the head from the front as previously shown in FIG. 4. The head has a leading edge 10 here shown as rectangular and generally centered upon the thickness of the head. The head has a top 10b shown rounded and upward, and a bottom 10a opposite the top shown also rounded and downward from the center of the leading edge. The head has a generally rectangular form in a front view of approximately the same width as the handle.

Turning the head from FIG. 5, the surface 11 shows a bottom view of the head in FIG. 7. The surface has a rectangular form with its length parallel to the width of the handle. The surface has two holes 14 that admit the screws 8 that connect the head to the first end of the handle. The surface proceeds to the left in the figure and intersects with the leading edge 10. At the intersection, the head has an edge 12 generally upright. Opposite the surface, the edge 12 meets with the top 10b of the leading edge which then rounds over to the front of the leading edge 10.

Rotating the head from FIG. 7, FIG. 8 shows a top view of the head previously first described in FIG. 2. The leading edge 10 extends across the width of the head 2 and rounds over to the bottom 10a that continues as the second surface 15. The channel 9 also extends across the width of the head through the second surface and into the thickness of the head. The channel is spaced away from the bottom, generally inwardly upon the head. Away from the channel and the leading edge, the second surface has two counter-bored holes 14 for the screws 8 that secure the head to the first end. Though two holes 14 are shown, the number of holes can be adjusted for different sizes of screws. In an alternate embodiment, the head is joined to the first end by an adhesive.

From the aforementioned description, a mounting lever has been described. The mounting lever is uniquely capable of lifting a sidewall of a tire, particularly the bead, up and over the rim of a wheel, all the while without marring wheels, and without damaging beads and tire walls. The lever is predominantly made from flat bar steel with a head made from polyethylene or nylon to prevent marring of wheels. The mounting lever and its various components may be manufactured from many materials, including but not limited to, polymers, polyvinyl chloride, high density polyethylene, polypropylene, nylon, steel, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A device for placing a bead of a tire and adjacent sidewall upon the rim of a wheel, without marring said wheel, comprising:
an elongated flat handle having a first end and an opposite second end, a thickness, a length, and a width, said handle being made of a material that resists bending as during usage; and,
a head connecting to said first end and covering the thickness and the width of said first end and having a channel across said head locating away from said handle and proximate said first end, said head being made of a non-marring material.

2. The bead placing device of claim 1 further comprising:
said head having a leading edge outward from said channel across the width of said first end, a thickness, and a length, the length of said head being less than the length of said handle, the thickness of said head being at least that of the thickness of said handle.

3. The bead placing device of claim 2 further comprising:
said leading edge having a top generally coplanar with said handle and a bottom opposite said top and spaced below said handle;
said bottom adjoining said channel;
said head securing to said handle upon at least one point away from said channel and opposite said; and,
said head having a width not exceeding the width of said handle.

4. The bead placing device of claim 3 further comprising:
said channel having a cross section selected from one of semi-circular, elliptical, or V shape.

5. The bead placing device of claim 4 further comprising:
said channel having a semi-circular cross section;
said head having a rear edge opposite said leading edge; and,
said top, said bottom, and said rear edge being rounded.

6. The bead placing device of claim 3 wherein said head secures to said handle using one of screws, bolts, or rivets.

7. The bead placing device of claim 6 further comprising:
said handle having two threaded holes proximate said first end;
said head having two counter-bored holes away from said channel and opposite said bottom; and,
two screws advancing through said counter-bored holes into said threaded holes.

8. The bead placing device of claim 3 further comprising:
said head having a first planar surface at a generally right angle to said top of said leading edge, said surface and said top cooperating to receive said first end of said handle; and,
said head having a second planar surface parallel to and spaced apart from said first surface.

9. (canceled)
